(19) United States
(12) Patent Application Publication
(10) Pub. No.: US 2017/0039641 A1
(43) Pub. Date: Feb. 9, 2017

(54) REAL-TIME ROUTING SYTEM AND ASSOCIATED METHODOLOGY FOR ADAPTING ORDER FLOW FOR ENHANCED EXECUTION PERFORMANCE

(71) Applicant: SUNGARD BROKERAGE & SECURITIES SERVICES LLC, Geneva, IL (US)

(72) Inventors: David THULSON, Geneva, IL (US); John JANNES, Weston, CT (US)

(73) Assignee: SUNGARD BROKERAGE & SECURITIES SERVICES LLC, Geneva, IL (US)

(21) Appl. No.: 14/816,941

(22) Filed: Aug. 3, 2015

(51) Int. Cl. G06Q 40/04

(52) U.S. Cl. CPC G06Q 40/04

(57) ABSTRACT

Systems and methods for real-time routing and retail order now adaptation to enhance execution performance can be configured to receive an order from a customer including a product identifier, order characteristics, and pricing information; identify a set of appropriate market venues based on the product identifier and/or order characteristics; determine expected behavior of the market venues based on historical data for executed orders and real-time order statistics; select, based upon expected behavior, a first market venue; and route the order, in real-time, to the first market venue for fulfillment.

### BACKGROUND

Broker systems route held orders including orders from retail investors to a variety of venues for execution including market makers, alternative trading systems (ATSs), and registered exchanges. Retail orders are defined as orders from individual investors. Held orders are orders where the executing broker/market maker is obligated to fill, display, or route the order to another venue immediately and are benchmarked against the current National Best Bid and Offer (NBBO) on arrival.

Brokers have an obligation to their customers to obtain the best price for orders received from their customers and to regularly review how the orders were executed and where the orders are routed to be filled. Existing retail order routing systems generally employ rigid routing schemes that process all orders for a given equity to a single broker, or group of brokers and typically are updated manually. Performance of such routing schemes is typically reviewed once per quarter using metrics as described in Security & Exchange Commission (SEC) Rule 605.

Existing systems are not generally optimal in that they are incapable of dynamically adapting to changes in the market or behavior of various trading venues.

### SUMMARY

In some embodiments, a centrally managed network-based order processing system is provided for routing held orders including orders from retail investors to a variety of trading venues including market makers. ATSs, and registered exchanges. Retail orders include orders from individuals. Held orders are orders where the executing broker/market maker is obligated to fill, display, or route the order to another market venue immediately and the fill price is benchmarked to the NBBO on arrival. The order processing system may include one or more computing systems, servers and/or routing engines that are configured to determine execution quality of trades as they occur as well as rank venues and optimize routing for each order in real-time. The order processing system may be configured to adaptively update order routing by taking into account historical order routing data in addition to real-time order statistics and live market data.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a block diagram of an exemplary network topology of an order routing system, according to certain embodiments;

FIG. 2 is a block diagram of an exemplary processing module configuration of the order routing system of FIG. 1;

FIG. 3 is a block diagram of an exemplary calculation method for determining the effective over quoted spread characteristic;

FIG. 4 is a flowchart of an exemplary order routing process;

FIG. 5 is a flowchart of an exemplary historical data generation process;

FIGS. 6A-6D are a block diagrams of exemplary decision flows for routing a series of limit orders in accordance with the order routing process of FIG. 4;

FIG. 7 illustrates a block diagram of an example computing device.

In the drawings, like reference numerals designate identical or corresponding parts throughout the several views.

### DETAILED DESCRIPTION

Systems and methods for adapting held order flow to enhance order execution performance are configured to determine execution quality of order fulfillment in real-time as orders are executed by market venues (e.g., market makers, ATSs, or registered exchanges), evaluate relative market venue performance based upon real-time execution quality metrics as well as historic performance data, and optimize routes for subsequent orders in real-time based upon venue performance evaluations relevant to characteristics of the present order.

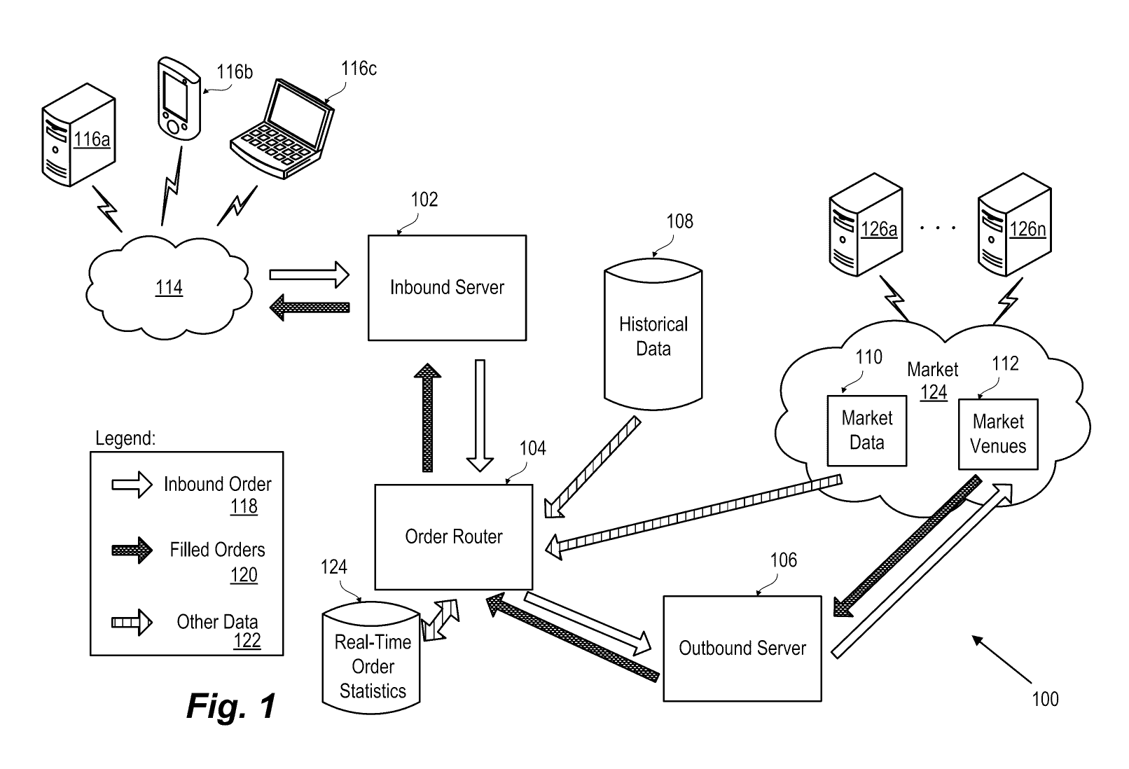

FIG. 1 is a block diagram of an exemplary order routing system 100, including one or more processing systems (e.g., processors, computing devices, servers, virtual machines, parallel processing threads, etc.), such as an inbound server 102, order router 104, and outbound server 106, that are configured to receive orders 118 submitted by customers 116, determine an appropriate market venue 126 for fulfillment of each of the orders 118 based on expected behaviors of the market venues 126, route the orders 118 to the selected market venues 126, and update market venue statistics in real-time based on actual fill data 122 to refine the expected behaviors of the market venues 126. The order routing system 100 communicates with customers 116, such as end retail investors and/or retail brokers, via a customer network 114. As such, a particular order may be submitted directly to the order routing system 100 via a customer computing device 116a or 116b, or the order may reach the order routing system 100 via one or more intermediary computing systems, such as a retail brokerage computing system 116c. The customer network 114, depending upon the deployment configuration of the order routing system 100, may include the Internet, one or more intranets, local area networks (LANs), Wide Area Networks (WANs), and/or Metropolitan Area Networks (MANs). Further, although the customer devices 116 are illustrated as communicating with the customer network 114 through wireless connections, depending upon the deployment configuration, some customer devices 116 may communicate with the customer network via a wired or cabled connection. Upon determining an appropriate route for the particular order, the order routing system 100 routes the particular order to a selected market venue 126 via a market network 124 which may include similar network components as described, in relation to the customer network 114. Additionally, in some embodiments, at least a portion of the networking configuration of the customer network 114 may be shared with the market network 124.

In some embodiments, the inbound router 102 receives customer orders 118 placed by customers via the customer network 114. The customers may place the orders 118 directly to the inbound router 102 via customer computing devices such as customer devices 116a, 116b and/or the orders 118 may be submitted by one or more intermediate computing systems 116c on behalf of the customers. In some examples, a particular customer may place an order with the inbound server 102 through the intermediate computing system 116c via a web interface, handheld device application, or telephone interface. The inbound server 102 may normalize the orders 118 prior to providing the orders 118 to the order router 104. For example, the inbound server 102 converts customer-specific order formats into a common format that corresponds to a format that used by the order router 104 for making trading/routing decisions. The order router 104, in turn, may make trading/routing decisions, such as selecting market venues 112 for routing the orders 118 based on expected behaviors of the market venues 112.

The outbound server 106, in some embodiments, receives the order routing data 118 from the order router 104 and formats the orders 118 for the market venues 112. Once the orders 118 are filled by the market venues 112, the outbound server 106 may normalize actual fill data 120 received from the market venues 112 and pass the actual fill data 120 to the order router 104 where real-time order statistics 124 are updated. For example, individual market venues may process orders based on a venue-specific format, so the outbound server converts the order data from the order router 104 to the venue-specific format when placing the order. The real-time order statistics 124 can also be based in part on market data 110 reflecting order activity external to the order routing system 100 (e.g., orders placed via other order placement systems in communication with the market venues 112).

As will be discussed further herein, the order router 104, in some embodiments, makes order routing decisions based on the real-time order statistics 124 as well as historical data 108. In one example, a database server (not illustrated) includes processing circuitry configured to process the historical data 108. In another example, a database server stores the historical data 108, which is processed by the order router 104. The order router 104 may also route the actual fill data 120 to the inbound server 102, which may format the fill data 120 in accordance with customer (or third party intermediary) specifications.

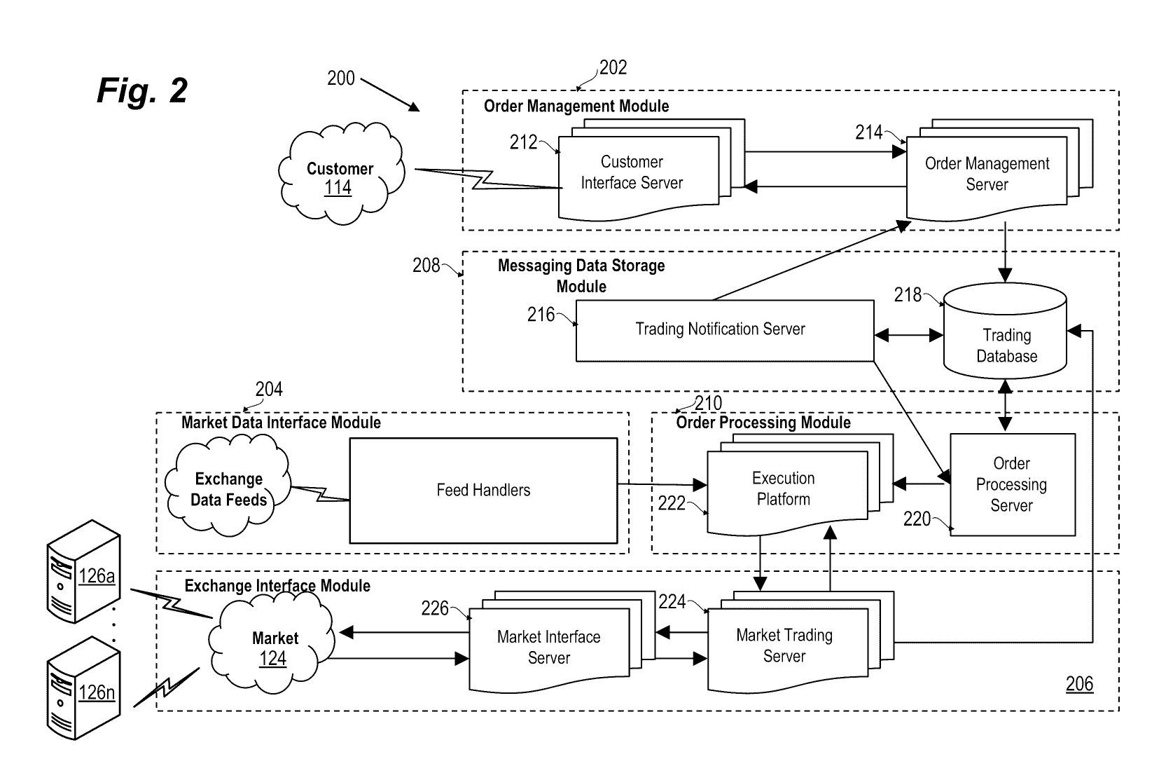

FIG. 2 is a block diagram of an exemplary processing module configuration 200 of the order routing system 100 of FIG. 1, according to certain embodiments. The processing module configuration 200 provides a detailed processing flow for the routing of orders through the order routing system 100. The processing module configuration 200 includes a number of discrete processing modules, such as an order management module 202, a message data storage module 208, a market data interface module 204, an order processing module 210, and an exchange interface module 206, for handling order receipt and fulfillment. Each module may include one or more routers/servers or other processing circuitry that executes the processes described herein. The distribution of processing circuitry shown in the processing module configuration 200 is merely exemplary and other computing systems, processing circuitry, and/or distribution of processing tasks may be used.

In some embodiments, the inbound server 102 of the order processing system 100 of FIG. 1 includes the order management module 202. The order management module 202 may include a customer interface server 212 that receives a customer order via the network 114. The customer interface server 212 may send an order acknowledgement to the customer and route the order to an order management server 214. The order management server 214 may validate the order to ensure the order is in accordance with customer specifications and then transmit the order to the messaging data storage module 208.

The inbound server 102, in some embodiments, includes the messaging data storage module 208, having a trading database 218 as well as a trading notification server 216. The order transmitted from the order management module 202 to the messaging data storage module 208 may be posted to the trading database 218. The trading notification server 216 may identify a new order in the trading database 218 and notify an order processing server 220 in the order processing module 210. In some embodiments, the outbound server 106 of FIG. 1 includes the order processing module 210. The order processing server 220 may query the trading database 218 in response to the notification to obtain the order information from the trading database 218.

In addition to the order processing server 220, in some embodiments, the order processing module 210 also includes an execution platform 222. The order processing server 220 may provide the order to the execution platform 222, and the execution platform 222 may determine routing information for the order based on customer trading specifications, the historical data, and real-time order statistics. In one example, the real-time order statistics are based on live market data received from the market data interface module 204 (e.g., included as part of the order router 104 of FIG. 1). The execution platform 222 may send the order routing information to a market trading server 224 in the exchange interface module 206.

In some embodiments, the outbound server 106 of FIG. 1 includes the exchange interface module 206. Within the exchange interface module 206, the market trading server 224 routes the order according to the order routing information to an instance of an market interface server 226 associated with a particular market destination 228 identified by the order routing information. The selected instance of the market interface 226 may format the order in a messaging format corresponding to the selected market destination 228. The market interface server 226 may route the order to the selected market destination 228 via the network 124, where the order is filled.

Upon fulfillment, in some embodiments, the market interface server 226 receives the actual fill data, which can also be referred to as fill details, via the network 230 from the market venue 126 and routes the actual fill data back to the market trading server 224. The market trading server 224 may post the fill details to the trading database 218 of the messaging data storage module 210 and also provide the fill details to the execution platform 222 of the order processing module 210 in a normalized format. The execution platform 222 may update the real-time order statistics based on the actual fill data so that future orders are based on the requested fill data from a current order.

At the messaging data storage module 208, the trading notification server 216, in some embodiments, identifies the fill details posted to the trading database 218 and sends the fill details to the order management server 214 of the order management module 202. The order management server 214 may provide the fill details to the customer interface server 212, and the customer interface server 212 may route the fill details to the customer via the network 114 in a predetermined format. Customers who initiate orders via the order routing system can specify one or more target metrics that are used by the order router 104 to make determinations regarding where orders are routed. Target metrics, in some examples, can include execution speed, price improvement, fill rate, and the like. The order router 104 of FIG. 1, for example, can select the market venues 126 for routing received orders based at least in part on expected performance of the market venues 126 with respect to the customer's target metrics.

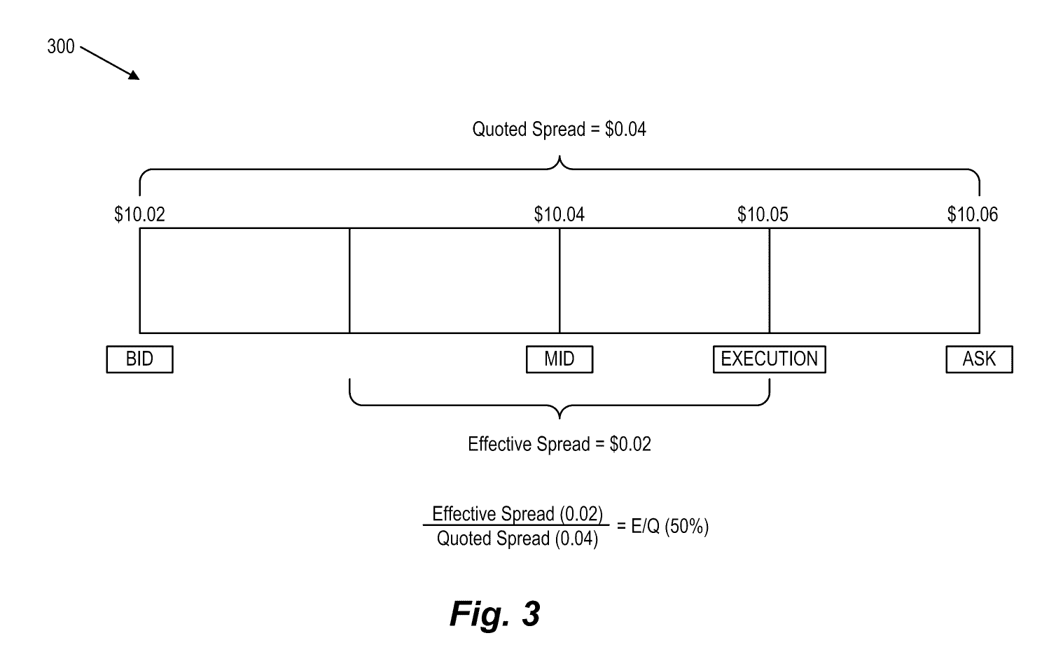

Turning to FIG. 3, a block diagram illustrates an exemplary calculation method 300 fir determining the E/Q target metric The E/Q target metric measures price improvement as a percentage of a quoted spread by dividing the effective spread by the quoted spread. For buy orders, the effective spread is the difference between the execution price and midpoint of the quoted spread multiplied by two. For example, as shown in FIG. 3, an order to buy 100 shares of XYZ at market is placed, and the quoted spread is $10.02×$10.06=$0.04 with a midpoint of $10.04. If the order is filled at $10.05, then the effective spread is $0.02, which results in an E/Q percentage of 50. The order routing system may rank market venues with lower E/Q spreads above those market venues with higher E/Q spreads.

The order routing system, in some embodiments, routes the received orders to the highest ranked market venues in accordance with the expected behaviors of the market venues and then updates the real-time order statistics based on the actual fill data. The market venues that are not the highest ranking market venue may be referred to as sub-optimal market venues. In some circumstances, the order routing system may route a portion of the received orders to lower-ranking (sub-optimal) market venues to increase an amount of actual data associated with the lower-ranking market venue available to the order routing system. For example, if a market venue having a third-ranked E/Q corresponds to less data than other market venues with respect to one classification, the order routing system may route to the third-ranked market venue so that the expected behavior of the market venue is based on a larger amount of data.

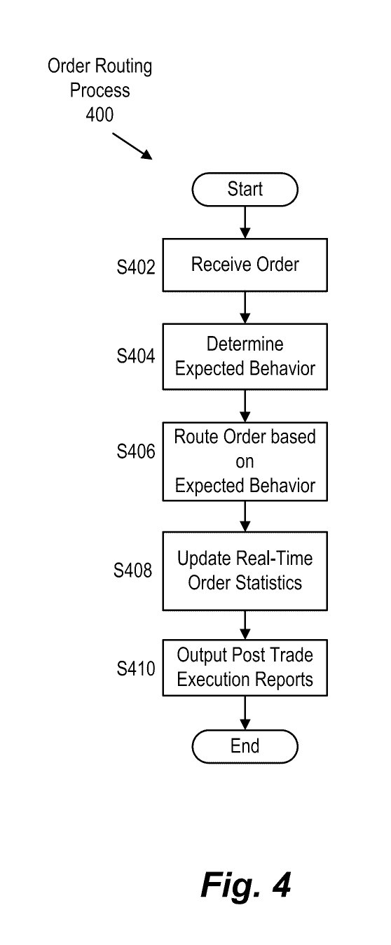

FIG. 4 is a flowchart of an exemplary order routing process 400. In some embodiments, the order router 104 of FIG. 1 is configured to route retail held orders to one or more market venues by taking into account real-time order statistics and historical data in accordance with the order routing process 400. The order routing process 400, in some embodiments, also obtains execution quality data for each order that is filled and updates the expected behavior of the market venues based on the actual data.

At step S402, the process 400 receives a customer order including a product identifier, an order type (e.g., buy, sell, etc.), and pricing information. The order may additionally include one or more target metrics (e.g., supplied by the customer or an intermediate system) such as, in some examples, E/Q, execution speed, price improvement, or fill rate. For example, the order can be a market order to trade a particular product (e.g., stock, bond, fund, etc.) identified by the product identifier according to the pricing information (e.g., at current market price or limit orders with instructions to trade but not beyond a given limit price). For a limit to be marketable, the order has a limit that is at or beyond the market price. For example, for a marketable buy order, the limit is greater than or equal to a current ask. For a marketable sell order, the limit is less than or equal to the current bid. Under certain circumstances, such as if the order is non-marketable or if a quote is available, the order routing system 100 may route the order directly to a registered exchange in order to optimize the target metric(s).

At step S404, the process 400 determines an expected behavior of the market venues with respect to the characteristics of the order and the one or more target metrics. The order received at step S402 may be classified, also referred to as bucketed, based on one or more characteristics of the order because market venue performance varies based on the characteristics of the received orders. According to one embodiment, the order may be classified based on product identifier (e.g., symbol) and/or one or more order characteristics such as side (e.g., buy side or sell side), order type, order size, and marketability for limit orders. For example, one venue may have an expected E/Q of 95 (that is and effective over quoted spread of 95%) for trading 2000 shares of a theoretical stock XYZ but may also have an E/Q of 80 for trading 200 shares of stock XYZ.

In addition, different order size classifications can be implemented for each product identifier, for example due to different products having different quantities of shares quoted at a time or having a different average daily trading volume. In a particular example, a theoretical stock XYZ may have approximately one million shares quoted at a given time and trade millions of shares each day, while another theoretical stock ABC may only trade 2000 shares on most days. Given those differences, a 2000 share order of XYZ may trade differently than a 2000 share order of stock ABC. However, in other implementations, fixed size classifications may be implemented for each stock. In an illustrative example, SEC 605 metrics state that orders of fewer than 100 shares or greater than or equal to 10,000 shares are excluded, and the size classifications are 100-499, 500-1999, 2000-4999, and 5000-9999.

In some implementations, the order from the customer specifies at least one target metric for the order, such as the E/Q, fill rate, execution speed, and the like. The process 400, in this circumstance, may determine the expected behavior of the one or more market venues and rank the market venues with respect to the target metric(s). For example, for a target metric of E/Q, market venues having lower E/Qs are ranked higher than market venues having higher E/Qs. The expected behavior determined by the process 400 may be based on weighted real-time order statistics and historical data. In one example, the historical data is calculated over a predetermined period of time, such as once per day. For an initial order of the day after the historical data is calculated, the historical data is assigned a highest weighting factor such that the expected behavior of the market venues is based entirely on historical data. As the number of executed orders increases during the course of the day, the weighting of the real-time order statistics and historical data may be modified so that the real-time order statistics have a greater effect on the expected behavior, and the historical data have a lesser effect on the expected behavior.

In some implementations, at the start of a day after the historical data has been calculated, rather than performing routing based upon expected behavior, the order routing system performs a period of distributed (e.g., round-robin) routing where orders are routed to different market venues to determine an accuracy or applicability of the historical data. For example, for the orders filled at the beginning of a day, if the actual fill data differs from the historical data by an amount that is greater than a predetermined threshold, then the order routing system may underweight the historical data for the rest of the orders executed throughout the day.

At step S406, the order is routed to one of the market venues based on the expected behavior. The order routing system, for example, may route the received orders to the highest ranked market venue in accordance with the expected behaviors of the market venues. In another example, the order routing system may route the received orders to one or more sub-optimal market venues to increase an amount of data associated with each sub-optimal market venue. For example, if a market venue having a third-ranked E/Q has less data than all of the other market venues with respect to one classification of order, the order routing system may route to the third-ranked market venue so that the expected behavior of the market venue is based on a larger amount of data.

According to certain embodiments, the selection of market venues for the sub-optimal order routing is random, but in other embodiments, the sub-optimal order routing is based on increasing a number of orders filled at a market venue for each of the classifications in order to develop a statistically significant picture of how each of the sub-optimal market venues responds to orders assigned to the various types of classifications. In addition, the order routing system may modify probabilities associated with the expected behaviors of the market venues so that the lowest-ranking market venues are less likely to be selected for s routing. In some embodiments, the sub-optimal market venues with expected behaviors within a predetermined range of the highest-ranking market venue are more likely to be selected for routing. In a particular example, if there are three market venues with expected E/Qs of 80, 81, and 150, the market venue with the expected E/Q of 150 will not be selected for order routing, but the order routing system may distribute orders between the market venues with the E/Qs of 80 and 81 (e.g., randomly, round-robin, weighted by actual E/Q, etc.) during order routing.

At step S408, the process 400 updates the real-time order statistics based on actual fill data and, optionally, live market data. In some implementations, the order routing system updates all of the possible target metrics and not just the target metric selected by the customer for the order. For example, if a first order is targeting the fastest fill time target metric, the order routing system may also update the E/Q fill data for the first order so that a second order identifying a best E/Q target metric will have the advantage of the actual fill data from the first order during route selection. The order routing system can also update the real-time order statistics in terms of pricing information, including, in some examples, the cost of the shares and market venue pricing information such as the fees and/or rebates provided by the market venues. In addition, price improvement can be measured in one or more types of units, such as raw dollars, percentage of price, and the like.

According to some embodiments, the order routing system updates the real-time order statistics for the classifications associated with the executed order. The order routing system may also share data between the real-time classifications so that classifications related to the order but not specifically associated with the order can still be updated based on the actual fill data from the order. In an illustrative example, if the order routing system determines that venue A is expected to have an E/Q of 60, but a first order routed to venue A for a theoretical symbol ABC has an E/Q of 100, the order routing system can modify the expected behavior of the market venue relative to symbols that are deemed to be associated with symbol ABC to reflect the actual E/Q of 100. In one example, associated symbols include symbols of stocks that are from the same industry as symbol ABC so that if fill quality for symbol ABC deviates from the expected behavior, the order routing system may determine that the fill quality at other similar stocks could also experience similar changes.

At step S410, the order routing system generates post-trade execution reports based on the actual fill data. For example, the post trade execution reports can be delivered to the customer that indicate the actual fill data and an execution quality of the order at the market venue. Post-trade execution reports may be generated on a periodic basis such as, in some examples, daily, weekly, monthly, or quarterly. For example, the order routing system can generate execution quality reports in according with SEC Rule 605 as well as customer-specific post-trade execution reports that are tailored to target metrics and performance specifications associated with specific customers.

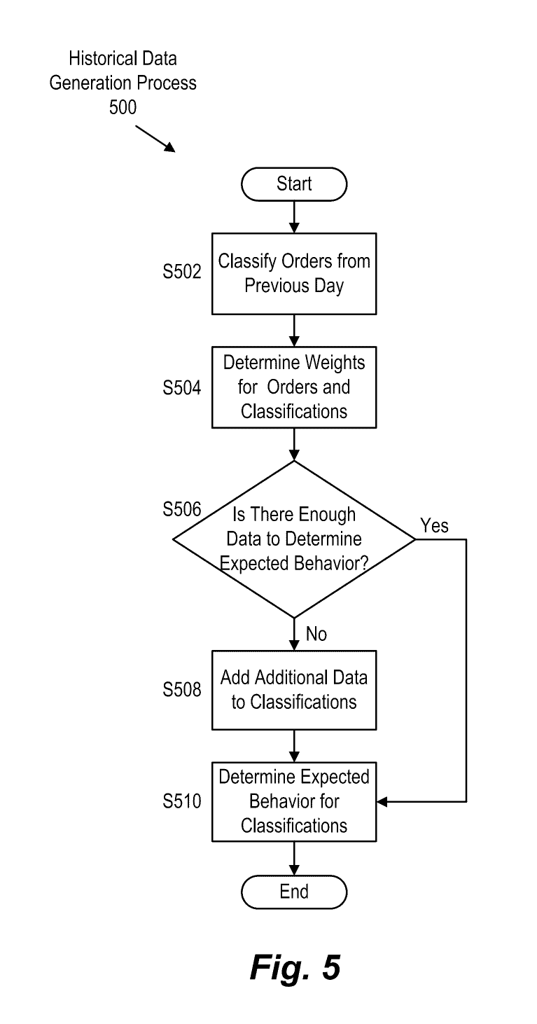

FIG. 5 is a flowchart, of an exemplary historical data generation process 500. In some implementations, the historical data generation process 500 is performed over a predetermined time period, such as a day, a week, a month, a quarter, etc. In a particular example, the predetermined time period is one day, meaning that the historical data is processed on a daily (e.g., every 24 hours) basis. In some implementations, the historical data generation process 500 may be executed by the order router 104 but can also be performed at least in part by another process and stored in a database server. In some embodiments, the process 500 is invoked to processes historical data from orders executed by an order routing system as well as external historical market data.

At step S502, the process 500 assigns orders executed over the predetermined time period to one or more historical classifications based on predetermined classification criteria. According to some embodiments, the historical classifications may be based on groupings based on domain knowledge of experts in the field, data mining processes, and/or machine learning techniques. Classifications may be based on related products rather than, or in addition to, individual product identifiers. For example, stock groupings may be based on indexes (e.g., the S&P Smallcap 600 index, the S&P Midcap 400 index, the S&P Health Care index, the DOW Industrials index, the DOW Transportations index, etc.), industry sectors (e.g., transportation, banking, biotechnology, etc.), issue type, or regional distinctions (e.g., by multi-country or continental region such as Europe or Central America, by country, by intra-country region such as United States—New England, etc.). Stocks may also be grouped by how the stocks behave in the market. In one implementation, the classification criteria may include factors such as the executing market venue and the size of the order, but other criteria can also be used such as the type of order, the amount of time the customer allows for filling the order, how limit prices compare to market prices for limit orders, and the like. The order routing system may also generate classifications based on machine learning techniques that determine groups in the historical data without or without expert human intervention or guidance.

In some embodiments, each order is assigned to at least one specific historical classification as well as an all,encompassing classification according to classification criteria. For example, executed orders that are greater than or equal to a predetermined number of shares may be classified as “large” orders, and executed orders that are less than the predetermined number of shares may' be classified as “small” orders. If a large order was executed at venue A, in a particular example, the order may be included in the “A/large” classification as well as in the “all_venues/large” classification, as well as the “A/all_sizes,” and “all_venues/all_sizes” classifications. In addition, executed orders that are routed with specialized instructions from the customer that result in the orders being handled differently may be disregarded by the process 500 or placed into one or more separate classifications designated for specialized orders.

At step S504, the process 500 determines weighting factors for the executed orders and the historical classifications. According to certain embodiments, the order routing system may determine the weighting factors for the executed orders based on one or more historical metrics such as, in some examples, overall effects of the order on the market, relative impact compared to other orders, target metrics, classification criteria, and the like. The order routing system may then use the weighting factors assigned to determine weights for each of the historical classifications. The historical classifications may also have more than one associated weighting factor. For example, the historical classifications may have different weighting factors for fill rate and E/Q.

At step S506, the process 500 determines whether an amount of historical data assigned to each historical classification s below a predetermined classification threshold. The data for the executed orders assigned to each of the historical classifications at step S502 may be used to determine expected behaviors for each of the historical classifications. However, one or more of the historical classifications may be under-represented and may have smaller amounts of data than other classifications, which may result in routing decisions based on unreliable historical data. The predetermined classification threshold may be defined, in some examples, as a number of executed orders assigned to the historical classification, a difference in number of executed orders assigned to a particular historical classification and the historical classification with the greatest number of executed orders within the classification group, a total monetary value (e.g., price times shares) assigned to the historical classification, a difference in a total monetary value assigned to a particular historical classification and the historical classification with the greatest monetary value within the classification group, and the like. If the amount of data assigned to one or more of the historical classifications is lower than the predetermined classification threshold, resulting in a “no” at step S506, then step S508 is performed. Otherwise, if the amount of historical data in the historical classifications is greater than or equal to the classification threshold, resulting in a “yes” at step S506, then step S510 is performed.

At step S508, if it is determined at step S506 that the amount of historical data related to at least one of the historical classifications is lower than the predetermined threshold, resulting in an under-represented classification, the process 500 increases the predetermined period of time for historical data classification and includes less recent historical data to the under-represented historical classification(s). To increase the reliability of the historical classifications, the order outing system may add older historical data from a previous time period (e.g., one or more hours, half day, day, week, month, etc.) to each of the under-represented historical classifications. For example, the order processing system may include historical data from a previous time period to the under-represented historical classifications until each under-represented historical classification reaches the predetermined classification threshold. In one example, less recent historical data may be added to each of the under-represented historical classifications only until a predetermined earliest time is reached, regardless of whether the predetermined classification threshold is reached. In some embodiments, more recent historical data is weighted more heavily that less recent historical data.

In some embodiments, rather than including historical data beyond the predetermined earliest time, the order routing system includes non-exact matches in the under-represented historical classifications to increase the reliability of the historical data. For example, data from historical classifications that share one or more factors with an under-represented historical classification can be combined with the under-represented historical classification. Data from the historical classifications sharing a greater number of common factors with the under-represented classification may be weighted more heavily than the historical classifications sharing fewer common factors with the under-represented classification.

At step S510, the process 500 determines the expected behavior for the historical classifications. When the amount of data assigned to the historical classifications is greater than or equal to the predetermined classification threshold, the order routing system may move to computing expected behaviors of the historical classifications based on the possible target metrics that can be selected by the customer when submitting an order, such as E/Q, fill rate, execution speed, price improvement, and the like. The order routing system may then use the expected behaviors derived from the data allocated to the historical classifications during the order routing process along with the real-time order statistics to determine expected behaviors for the market venues.

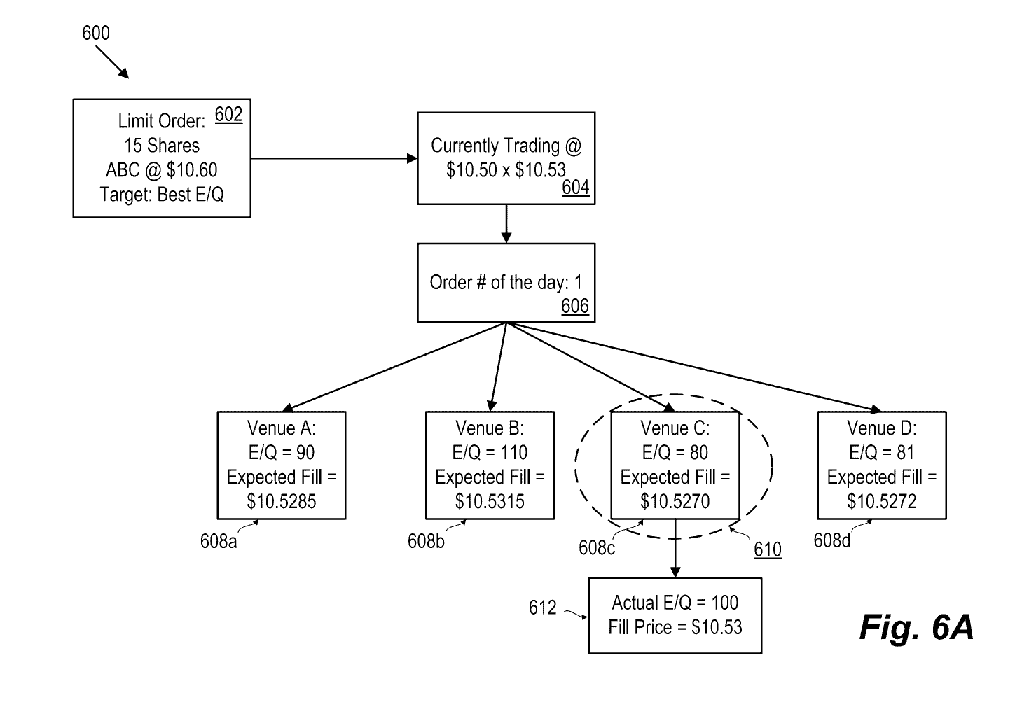

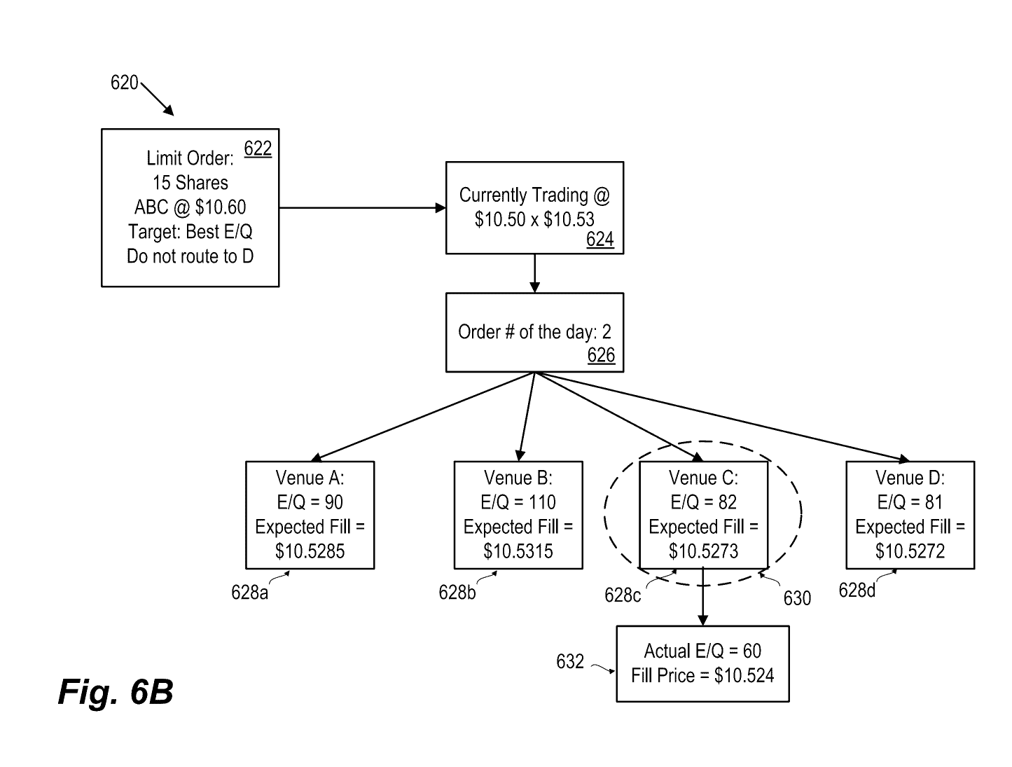

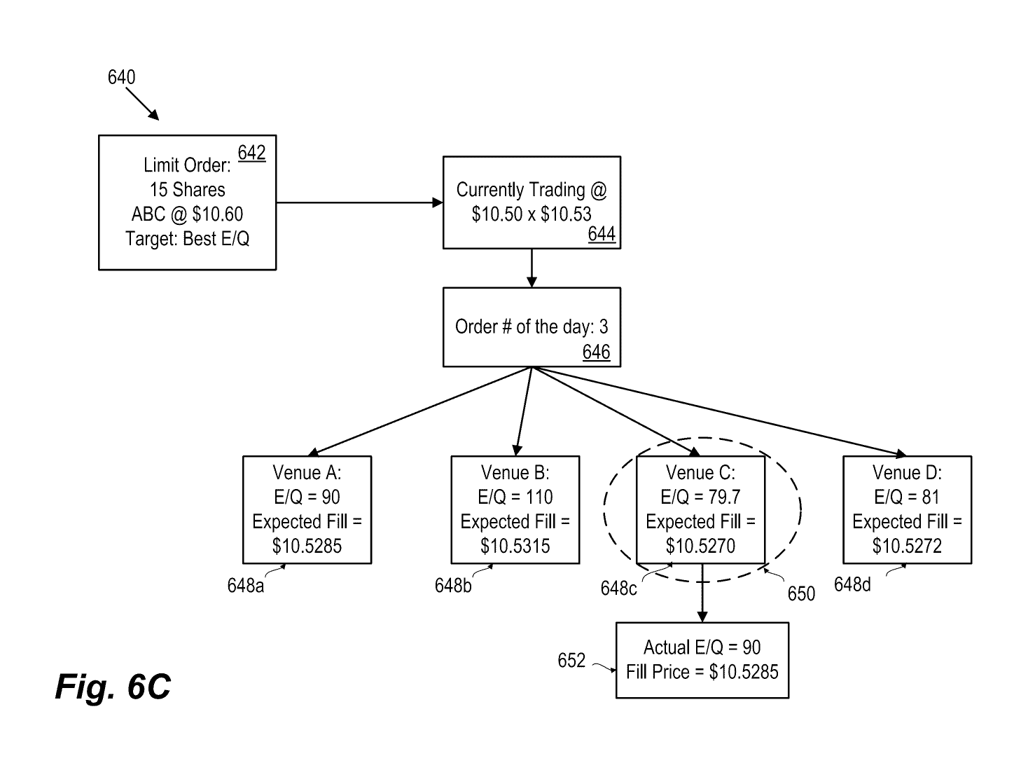

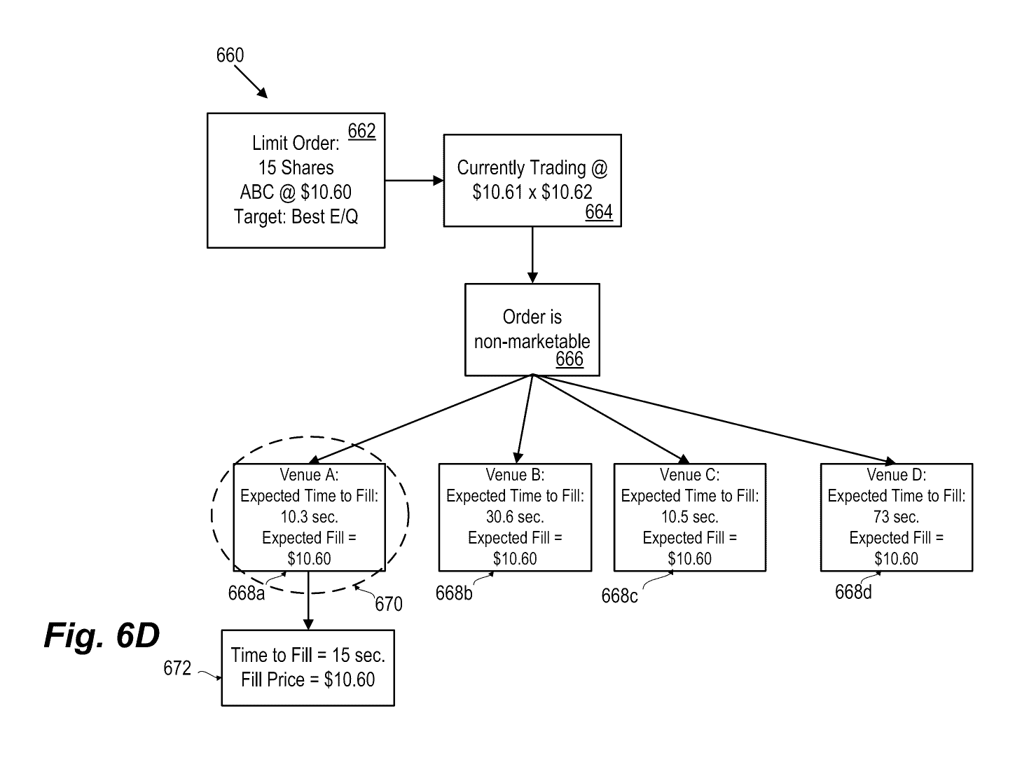

FIGS. 6A through 6D are block diagrams of exemplary decision flows for routing a series of limit orders in accordance with the order routing process of FIG. 4. For example, FIG. 6A illustrates a routing decision flow 600 for a limit order that is an initial order routed after computing the historical data for a predetermined time period (e.g., twelve hours, one day; forty-eight hours, one week, etc.). The routing decision flow 600 receives (602) the limit order to buy fifteen shares of a theoretical stock ABC at $10.60 with a target metric of best E/Q, The decision flow 600 determines (604) that ABC is currently trading at $10.50×$10.53. The limit order, in some examples, may be classified according to at least one of product identifier (e.g., symbol ABC), side, order size, order type, and marketability (for limit orders).

Since the routing decision flow 600 determines that the limit order is the initial order of the day (606), the routing decision flow 600 determines the expected behavior (608) of each of the market venues A, B, C, and D based on the historical data alone. For example, based on the historical data, venue A has an expected E/Q of 90 with an expected fill price of $10.5285, venue B has an expected E/Q of 110 with an expected fill price of $10.5315, venue C has an expected E/Q of 80 with an expected fill price of $10.5270, and venue D has an expected E/Q of 81 with an expected fill price of $10.5275. Since the best E/Q is being targeted, the routing decision flow 600 ranks venue C highest followed by venue D, venue A, and venue B. The routing decision flow 600 thus selects (610) venue C for order routing. The routing decision flow 600 receives (612) order execution results with an actual fill price of $10.53, which corresponds to an actual E/Q of 100. The real-time order statistics may consequently be updated (e.g., by the order router 104 of FIG. 1) to reflect that the actual order E/Q was 100 for venue C.

Turning to FIG. 6B, an exemplary routing decision flow 620 tracks a second limit order of the day. The routing decision flow 620 receives (622) a limit order to also buy fifteen shares of stock ABC at $10.60 with a target metric of best E/Q, in addition, the customer has included an additional instruction to not route to venue D. The routing decision flow 620 determines (624) that ABC is currently trading at $10.50×$10.53 and identifies (626) that the order is the second order of the day. As such, the routing decision flow 620 determines the expected behavior of the market venues A, B, and C based on both the historical data and the real-time order statistics from the order received during the routing decision flow 600 of FIG. 6A.

The routing decision flow 620 determines an expected E/Q of 82 with a corresponding fill price of $10.5273 for venue C based on both the historical data and the real-time order statistics from the routing decision flow 600 where the actual E/Q was 100. In addition, just as with the order 600, venue A has an expected E/Q of 90 with an expected fill price of $10.5285 and venue B has an expected E/Q of 110 with an expected fill price of $10.5315 Although venue D has an expected E/Q of 81, which would rank venue D higher than venue C, the customer instructed that the order not route to venue D. As such, the routing decision flow 620 selects (630) venue C once again for order routing. The routing decision flow 620 receives (632) routing results (632) related to fulfillment of the order via venue C with an actual fill price of $10.524, which corresponds to an actual E/Q of 60. The real-time order statistics may consequently be updated (e.g., by the order router 104 of FIG. 1) to reflect that the actual order EA) was 60 for venue C.

Turning to FIG. 6C, an exemplary routing decision flow 640 tracks a third limit order of the day. The routing decision flow 640 receives (642) a limit order to buy fifteen shares of stock ABC at $10.60 with a target metric of best E/Q. The routing decision flow 640 determines (644) that ABC is currently trading at $10.50×$10.53. The routing decision flow 640 identifies (646) that the order is the third order of the day so the routing decision flow 640 determines (648) the expected behavior of the market venues A, B, C, and D based on both the historical data and the real-time order statistics from the first order described in relation to FIG. 6A and the second order described in relation to FIG. 6B. The actual E/Q of 60 at venue C for the second order (described in relation to FIG. 6B) results in an expected E/Q determination of 79.7 for venue C with a corresponding expected fill price of $10.5270. The expected E/Qs and fill prices for venues A, B, and C remain the same as for the order. Since the best E/Q is being targeted, venue C is once again ranked highest followed by venue D, venue A, and venue B. The routing decision flow 640 selects (650) venue D for order routing. The routing decision flow 640 receives routing results (652) related to fulfillment of the order via venue C with an actual fill price of $10.5285, which corresponds to an actual of 90. The real-time order statistics may consequently be updated (e.g., by the order router 104 of FIG. 1) to reflect that the actual order E/Q was 90 for venue C.

As shown in FIG. 61), an exemplary routing decision flow 660 tracks a non-marketable order. The routing decision flow 660 receives (662) a limit order to buy fifteen shares of stock ABC at $10.60 with a target metric of best E/Q. The routing decision flow 660 determines (664) that stock ABC is currently trading at $10.61×$10.62. Since the order limit of $10.60 is less than the price at which ABC is currently trading, the order is non-marketable, and the routing decision flow 660 classifies (666) the order with other non-marketable orders, which may not be immediately filled. Because all venues have an expected fill price of 10.60 (the order's limit), the routing decision flow 660 then uses a secondary target metric, such as expected time to fill or fill rate. In one implementation where time to fill is the secondary target metric, the routing decision flow 660 determines (668) the expected behavior of the market venues A, B, C, and D based on both the historical data and the real-time order statistics with respect to time to fill. For example, venue A has an expected time to fill of 10.3 second, venue B has an expected time to fill of 30.6 second, venue C has an expected time to fill of 10.5 seconds, and venue D has an expected time to fill of 73 seconds. Since expected time to fill is the secondary target metric, venue A is ranked highest, followed by venue C, venue B, and venue D. The routing decision flow 660 selects (670) venue A for routing. The routing decision flow 660 receives routing results (672) related to fulfillment of the order via venue A with an actual time to fill of 15 seconds. The real-time order statistics may consequently be updated (e.g., by the order router 104 of FIG. 1) to reflect that the actual order fill time was 15 seconds for venue C.

According to some implementations, the processing circuitry of the order router 104 may also route orders directly to registered exchanges at times based on order classifications, such as whether the order is marketable or non-marketable, time of day, and the like. In one implementation, the order router 104 routes orders to the market venues early in the day and then routes the orders directly to the actual exchanges later in the day.

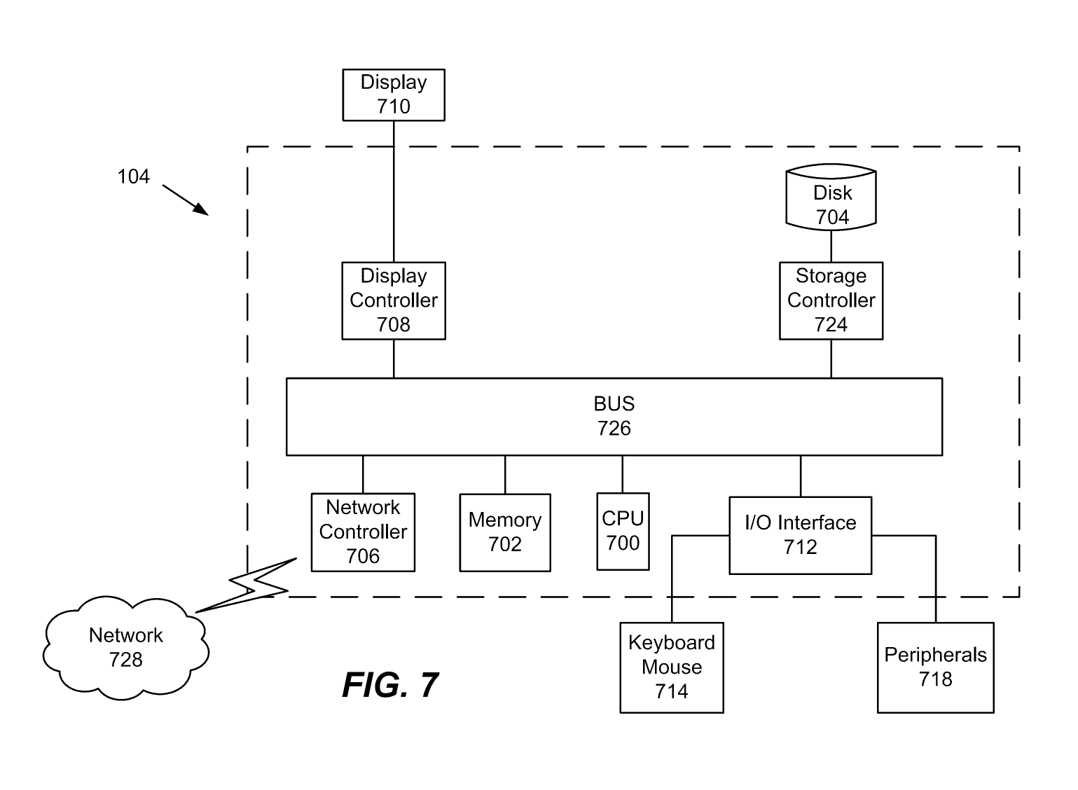

Note that each of the functions of the described embodiments may be implemented by one or more processing circuits. A processing circuit includes a programmed processor (for example, processor 700 of FIG. 7), as a processor includes circuitry. A processing circuit/circuitry may also include devices such as an application specific integrated circuit (ASIC) and conventional circuit components arranged to perform the recited functions. The processing circuitry can be referred to interchangeably as circuitry throughout the disclosure. In addition, when the processors in each of the servers are programmed to perform the processes described herein, they become special-purpose order routing devices. The processes performed by the order router 104 to as well as the other servers of the order routing system 100 are computationally rigorous due to the large amount of data that is processed to determine routing destinations for received orders. For example, updating the real-time order statistics and historical data can involve processing gigabytes of data in real-time. In addition, the servers of the order routing system 100 can perform the processes described herein in parallel to increase processing speed and efficiency.

A hardware description of an exemplary computing device is described with reference to FIG. 7. The hardware described by FIG. 7 can apply to any of the hardware components of the order routing system 100 such as the inbound server 102, order router 104, and outbound server 106. When the order router 104, the inbound server 102, and the outbound server 106 are programmed to perform the processes related to order routing described herein, the order router 104, the inbound server 102, and/or outbound server 106 becomes a special purpose device. Implementation of the processes of the order routing system 100 on the hardware described herein improves the efficiency of routing orders to optimal market venues and determining execution quality of the filled orders in real-time, in addition, the processes described herein can also be used in other types of applications and technologies that include allocating resources to locations and/or entities that are able to produce a desired result.

The exemplary computing device includes a CPU 700 that can be configured to perform the processes described herein. The process data and instructions may be stored in memory 702. These processes and instructions may also be stored on a storage medium disk 704 such as a hard drive (HDD) or portable storage medium or may be stored remotely.

CPU 700 may be a Xenon or Core processor from Intel of America or an Opteron processor from AMD of America, or may be other processor types that would be recognized by one of ordinary skill in the art. Alternatively, the CPU 700 may be implemented on an FPGA, ASIC, PLD or using discrete logic circuits, as one of ordinary skill in the art would recognize. Further, CPU 700 may be implemented as multiple processors cooperatively working in parallel to perform the instructions of the inventive processes described above.

The computing device in FIG. 7 also includes a network controller 706, such as an Intel Ethernet PRO network interface card from Intel Corporation of America, for interfacing with a network 728, such as the customer network 114 or the market network 124 of FIG. 1. As can be appreciated, the network 728 can be a public network, such as the Internet, or a private network such as an LAN or WAN network, or any combination thereof and can also include PSTN or ISDN sub-networks. The network 728 can also be wired, such as an Ethernet network, or can be wireless such as a cellular network including EDGE, 3G and 4G wireless cellular systems. The wireless network can also be Wi-Fi, Bluetooth, or any other wireless form of communication that is known.

The computing device further includes a display controller 708 for interfacing with display 710 of the order router 104, such as an LCD monitor. A general purpose I/O interface 712 at the order router 104 interfaces with a keyboard and/or mouse 714. General purpose I/O interface 712 also connects to a variety of peripherals 718 including printers and scanners.

The general purpose storage controller 724 connects the storage medium disk 704 with communication bus 726, which may be an ISA, EISA, VESA, PCI, or similar, for interconnecting all of the components of the computing device. A description of the general features and functionality of the display 710, keyboard and/or mouse 714, as well as the display controller 708, storage controller 724, network controller 706, sound controller 720, and general purpose I/O interface 712 is omitted herein for brevity as these features are known.

Although the computing device of FIG. 7 is described as having a storage medium disk 704, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates.

Further, the claimed advancements may be provided as a utility application, background daemon, or component of an operating system, or combination thereof, executing in conjunction with CPU 700 and an operating system such as Microsoft Windows, UNIX, Solaris, LINUX, Apple MAC-OS and other systems known to those skilled in the art.

In other alternate embodiments, processing features according to the present disclosure may be implemented and commercialized as hardware, a software solution, or a combination thereof. Moreover, instructions corresponding to the order routing process 400 and/or historical data generation process 500 in accordance with the present disclosure could be stored in a portable drive such as a USB Flash drive that hosts a secure process.

A number of implementations have been described. Nevertheless, it will be understood that various modifications may be made without departing from the spirit and scope of this disclosure. For example, preferable results may be achieved if the steps of the disclosed techniques were performed in a different sequence, if components in the disclosed systems were combined in a different manner, or if the components were replaced or supplemented by other components. The functions, processes and algorithms described herein may be performed in hardware or software executed by hardware, including computer processors and/or programmable circuits configured to execute program code and/or computer instructions to execute the functions, processes and algorithms described herein. Additionally, an implementation may be performed on modules or hardware not identical to those described. Accordingly, other implementations are within the scope that may be claimed.

1. A system comprising:
processing circuitry executing upon at least one computing device; and
a non-transitory computer readable medium, coupled to the processing circuitry, storing machine-executable instructions operable when executed on the processing circuitry to cause the processing circuitry to:
receive, via a network from a first customer computing system of a plurality of customer computing systems, an order comprising a product identifier, one or more order characteristics, and pricing information;
access historical data for executed orders fulfilled by the plurality of market venues over a prior period of time, wherein the historical data is relevant to at least one of the one or more order characteristics;
determine a set of real-time order statistics for a plurality of executed orders fulfilled by at least a portion of the plurality of market venues over a recent period of time, wherein each executed order of the plurality of executed orders is relevant to at least one of the one or more order characteristics;
apply the historical data and the real-time order statistics to determine an expected behavior of each market venue of the plurality of market venues;
select the first market venue based at least in part upon the respective expected behavior of the first market venue; and
route, in real-time, the order to the first market venue for fulfillment.

2. The system of claim 1, wherein selecting the first market venue comprises selecting the first market venue to optimize efficiency of order execution relative to a fill price.

3. The system of claim 1, wherein applying the historical data and the real-time order statistics to determine an expected behavior of each market venue of the plurality of market venues comprises weighting the historical data based at least in part on relative recency of two or more portions of the historical data.

4. The system of claim 1, wherein:
applying the historical data and the real-time order statistics to determine the expected behavior of each market venue comprises applying one or more weighting factors for weighting the historical data relative to the real-time order statistics; and
the instructions, when executed by the processing circuitry, further cause the processing circuitry to modify at least one weighting factor of the one or more weighting factors based on a total number of filled orders represented by the real-time order statistics.

5. The system of claim 4, wherein modifying the at least one weighting factor comprises decreasing a historical data weighting factor and increasing a real-time statistics weighting factor as a number of filled orders since generation of the historical data increases.

6. The system of claim 1, wherein the instructions, when executed by the processing circuitry, further cause the processing circuitry to:
receive, responsive to routing the order to the first market venue, actual fill data related to fulfillment of the order; and
update the real-time statistics based on the actual fill data.

7. A non-transitory computer readable medium having instructions stored thereon, wherein the instructions, when executed by the processor, cause the processor to:
receive, via a first network from a plurality of customer computing systems, a plurality of orders, each order of the plurality of orders comprising a respective product identifier, one or more respective order characteristics, and respective pricing information, wherein each order of the plurality of orders shares at least one order characteristic with the remaining orders of the plurality of orders;
identify, for each order of the plurality of orders, a respective market venue of a plurality of market venues for fulfillment of the order, wherein identifying the respective market venue comprises
accessing historical data for executed orders over a prior period of time, wherein the historical data is relevant to at least one of the one or more order characteristics,
determining a set of real-time order statistics for a plurality of executed orders fulfilled over a recent period of time, wherein each executed order of the plurality of executed orders is relevant to at least one of the one or more order characteristics,
applying the historical data and the real-time order statistics to determine an expected behavior of each market venue of the subset of market venues in fulfillment of the respective order, and
selecting the respective market venue based at least in part upon the expected behavior of the respective market venue;
route, in real-time via a second network, each order of the plurality of orders to the respective market venue for fulfillment;
receive, via the second network responsive to routing each order of the plurality of orders, respective actual fill data related to fulfillment of the respective order; and
update, in real-time, the real-time statistics based on the actual 1111 data of each executed order of plurality of executed orders;
wherein applying the historical data and the real-time order statistics to determine the expected behavior comprises applying, in relation to a later executed subset of the plurality of orders, real-time order statistics related to an earlier executed subset of the plurality of orders.

8. The non-transitory computer readable medium of claim 7, wherein the instructions, when executed by the processing circuitry, further cause the processing circuitry to assign the actual fill data of each order of the plurality of executed orders to at least one of a plurality of historical classifications, wherein assignment to a particular historical classification of the plurality of historical classifications is based on predetermined classification criteria.

9. The non-transitory computer readable medium of claim 8, wherein applying the historical data and the real-time order statistics to determine an expected behavior comprises:
identifying one or more historical classifications based on the one or more order characteristics; and
applying historical data classified in the at least one of the one or more historical classifications.

10. The non-transitory computer readable medium of claim 9, wherein the instructions, when executed by the processing circuitry, further cause the processing circuitry to:
analyze an amount of historical data in each of the one or more historical classifications;
identify that the respective amount of historical data in a first historical classification of the one or more historical classifications is less than a predetermined classification threshold; and
increase the predetermined prior period of time.

11. The non-transitory computer readable medium of claim 10, wherein the predetermined classification threshold is based on a total monetary value assigned to the one or more historical classifications.

12. The non-transitory computer readable medium of claim 8, wherein the instructions, when executed by the processing circuitry, further cause the processing circuitry to determine one or more weighting factors for weighting a respective subset of the actual fill data in each classification of the one or more historical classifications.

13. The non-transitory computer readable medium of claim 7, wherein at least a portion of the plurality of customer computing systems are associated with retail brokers.

14. A method for real-time routing of retail orders, comprising:
receiving, via a first network from a first customer computing system of a plurality of customer computing systems, an order comprising a product identifier, one or more order characteristics, and pricing information;
identifying, by processing circuitry, a subset of a plurality of market venues as appropriate market venues based at least in part on one or more of a) the product identifier, and b) at least one of the one or more order characteristics;
determining, by the processing circuitry, a set of real-time order statistics for a plurality of executed orders fulfilled over a recent period of time by the subset of market venues, wherein each executed order of the plurality of executed orders is relevant to at least one of the one or more order characteristics;
applying, by the processing circuitry, the real-time order statistics to determine an expected behavior of each market venue of the subset of market venues relative to at least one of the one or more order characteristics;
selecting, by the processing circuitry, a first market venue of the plurality of market venues based at least in part upon a comparison of respective expected behavior of each market venue of the plurality of market venues; and
routing, in real-time via a second network, the order to the first market venue for fulfillment.

15. The method of claim 14, wherein selecting the first market venue comprises ranking the respective expected behavior of each market venue of the plurality of market venues based on one or more target metrics.

16. The method of claim 15, wherein the one or more target metrics comprise at least one of an effective over quoted spread, a fill rate, an execution speed, and a price improvement.

17. The method of claim 14, wherein selecting the first market venue comprises selecting the first market venue as a sub-optimal market venue to increase the real-time order statistics related to the first market venue.

18. The method of claim 14, wherein selecting the first market venue comprises filtering the plurality of market venues to discard a subset of the plurality of market venues based upon a respective expected behavior of each market venue of the subset of market venues being outside of a predetermined range of a highest-ranking market venue.

19. The method of claim 18, wherein selecting the first market venue comprises, after filtering, making a random selection from a remaining subset of market venues.

20. The method of claim 14, wherein the plurality of orders comprise investment instrument orders.

21. The method of claim 14, wherein the one or more characteristics comprise at least one of a side, an order type, an order size, and a marketability value.
